(19) United States
(12) Patent Application Publication
(10) Pub. No.: US 2025/0264638 A1
(43) Pub. Date: Aug. 21, 2025

(54) OPTICAL COMPONENT, IMAGING LENS AND ELECTRONIC DEVICE

(71) Applicant: LARGAN PRECISION CO., LTD., Taichung City (TW)

(72) Inventors: Chi Wei CHI, Taichung City (TW); Chen Wei FAN, Taichung City (TW)

(73) Assignee: LARGAN PRECISION CO., LTD., Taichung City (TW)

(21) Appl. No.: 19/016,677

(22) Filed: Jan. 10, 2025

Related U.S. Application Data
(60) Provisional application No. 63/555,650, filed on Feb. 20, 2024.

(51) Int. Cl. G02B 1/11; G02B 13/18

(52) U.S. Cl. CPC G02B 1/11; G02B 13/18

(57) ABSTRACT

An optical component includes a substrate and an anti-reflective film. The substrate has an aspherical surface through which light passes. The anti-reflective film is disposed at least on the aspherical surface and includes a nanostructure layer and an intermediate layer. The nanostructure layer includes ridge-like protrusions that are non-directionally extended. A bottom of the ridge-like protrusions is closer to the substrate than a top of the ridge-like protrusions. The ridge-like protrusions gradually taper from the bottom toward the top. An average structural height of the ridge-like protrusions ranges from 108 to 368 nm. The intermediate layer is between the nanostructure layer and the substrate. A main component of the nanostructure layer is aluminum oxide. The nanostructure layer includes a metallic doping agent at least partially distributed inside the ridge-like protrusions. The metallic doping agent includes at least one of titanium, vanadium, chromium, titanium oxide, vanadium oxide, and chromium oxide.

### RELATED APPLICATIONS

This application claims priority to U.S. Provisional Application 63/555,650, filed on Feb. 20, 2024, which is incorporated by reference herein in its entirety.

### BACKGROUND

### Technical Field

The present disclosure relates to an optical component, an imaging lens and an electronic device, more particularly to an optical component and an imaging lens applicable to an electronic device.

### Description of Related Art

With the development of semiconductor manufacturing technology, the performance of image sensors has been improved, and the pixel size thereof has been scaled down. Therefore, featuring high image quality becomes one of the indispensable features of an optical system nowadays. Furthermore, due to the rapid changes in technology, smartphone devices equipped with optical systems are trending towards multi-functionality for various applications, and therefore the functionality requirements for the optical systems have been increasing.

In recent years, it has become increasingly popular to use miniature optical systems in mobile devices for photography. However, mobile devices are often affected by intense sunlight during outdoor use, causing the optical systems to be significantly impacted by strong non-imaging stray light. Especially the non-imaging light easily reflects within the optical systems, greatly reducing image quality.

Conventional techniques for optical systems involve methods such as inking, sandblasting, and coating the surfaces of optical elements to reduce reflectivity and eliminate stray light. Although these methods can improve optical image quality, they are still insufficient for eliminating high-intensity stray light. Furthermore, in the field of non-mobile device optical systems, there are other techniques for reducing reflectivity, such as forming porous microstructures on the surface of coatings. However, the structures lack sufficient support and are prone to deformation due to environmental factors, which significantly reduces anti-reflective effectiveness. Therefore, improving the structure of internal components in optical systems for reducing the reflection intensity of non-imaging light has become a critical issue to meet the high-end requirements for electronic devices nowadays.

### SUMMARY

According to one aspect of the present disclosure, an optical component includes a substrate and an anti-reflective film. Preferably, the substrate has an aspherical surface, and light passes through the aspherical surface. Preferably, the anti-reflective film is disposed at least on the aspherical surface. The anti-reflective film includes a nanostructure layer and at least one intermediate layer. The nanostructure layer includes a plurality of ridge-like protrusions that are non-directionally extended, a bottom of the ridge-like protrusions is located closer to the substrate than a top of the ridge-like protrusions, and the ridge-like protrusions gradually taper from the bottom toward the top. An average structural height of the ridge-like protrusions is greater than 108 nm and less than 368 nm. The intermediate layer is disposed between the nanostructure layer and the substrate. In addition, a main component of the nanostructure layer is aluminum oxide, the nanostructure layer further includes a metallic doping agent, and at least part of the metallic doping agent is distributed inside the ridge-like protrusions. Preferably, the metallic doping agent includes at least one of titanium, vanadium, chromium, titanium oxide, vanadium oxide and chromium oxide.

According to another aspect of the present disclosure, an optical component includes a substrate and an anti-reflective film. Preferably, the substrate has a reflection surface configured to reflect light. Preferably, the anti-reflective film is disposed at least on one or some surfaces of the substrate. The anti-reflective film includes a nanostructure layer and at least one intermediate layer. The nanostructure layer includes a plurality of ridge-like protrusions that are non-directionally extended, a bottom of the ridge-like protrusions is located closer to the substrate than a top of the ridge-like protrusions, and the ridge-like protrusions gradually taper from the bottom toward the top. An average structural height of the ridge-like protrusions is greater than 108 nm and less than 368 nm. The intermediate layer is disposed between the nanostructure layer and the substrate. In addition, a main component of the nanostructure layer is aluminum oxide, the nanostructure layer further includes a metallic doping agent, and at least part of the metallic doping agent is distributed inside the ridge-like protrusions. Preferably, the metallic doping agent includes at least one of titanium, vanadium, chromium, titanium oxide, vanadium oxide and chromium oxide.

According to another aspect of the present disclosure, an imaging lens includes one of the aforementioned optical components, and an optical axis of the imaging lens passes through the optical component.

According to another aspect of the present disclosure, an electronic device includes the aforementioned imaging lens and an image sensor disposed on an image surface of the imaging lens.

### BRIEF DESCRIPTION OF THE DRAWINGS

The disclosure can be better understood by reading the following detailed description of the embodiments, with reference made to the accompanying drawings as follows:

FIG. 1 is a cross-sectional view of an imaging lens according to the 1st embodiment of the present disclosure;

FIG. 2 is a cross-sectional view of an optical component of the imaging lens shown in FIG. 1;

FIG. 3 is an enlarged view of region EL3 shown in FIG. 2;

FIG. 4 is a perspective view of the optical component of the imaging lens shown in FIG. 1;

FIG. 5 is an enlarged view of region EL5 shown in FIG. 4;

FIG. 6 is another perspective view of the optical component of the imaging lens shown in FIG. 1;

FIG. 7 is an enlarged view of region EL7 shown in FIG. 6;

FIG. 8 is a partially enlarged cross-sectional view of the optical component of the imaging lens shown in FIG. 1 under a transmission electron microscope;

FIG. 9 is a partially enlarged cross-sectional view of the optical component of the imaging lens shown in FIG. 1;

FIG. 10 is a schematic view of the stacking relationship among a nanostructure layer, an intermediate layer and a substrate of the optical component of the imaging lens shown in FIG. 1;

FIG. 11 is a cross-sectional view of an imaging lens according to the 2nd embodiment of the present disclosure;

FIG. 12 is a cross-sectional view of an optical component of the imaging lens shown in FIG. 11;

FIG. 13 is a perspective view of the optical component of the imaging lens shown in FIG. 11;

FIG. 14 is a schematic view of the stacking relationship among a nanostructure layer, three intermediate layers and a substrate of the optical component of the imaging lens shown in FIG. 11;

FIG. 15 is a cross-sectional view of an imaging lens according to the 3rd embodiment of the present disclosure;

FIG. 16 is a cross-sectional view of an optical component of the imaging lens shown in FIG. 15;

FIG. 17 is a perspective view of the optical component of the imaging lens shown in FIG. 15;

FIG. 18 is a partially enlarged cross-sectional view of the optical component of the imaging lens shown in FIG. 15;

FIG. 19 is a sectional view of the optical component shown in FIG. 17;

FIG. 20 is a top view of the optical component shown in FIG. 17;

FIG. 21 is an enlarged view of region EL21 shown in FIG. 20;

FIG. 22 is a cross-sectional view of an imaging lens according to the 4th embodiment of the present disclosure;

FIG. 23 is a cross-sectional view of an optical component of the imaging lens shown in FIG. 22;

FIG. 24 is a cross-sectional view of an imaging lens according to the 5th embodiment of the present disclosure;

FIG. 25 is a cross-sectional view of an optical component of the imaging lens shown in FIG. 24;

FIG. 26 is a perspective view of an electronic device according to the 6th embodiment of the present disclosure;

FIG. 27 is another perspective view of the electronic device in shown FIG. 26;

FIG. 28 is an illustration of an image captured by an ultra-wide-angle imaging lens;

FIG. 29 is an illustration of an image captured by a high pixel imaging lens;

FIG. 30 is an illustration of an image captured by a telephoto imaging lens;

FIG. 31 is a perspective view of an electronic device according to the 7th embodiment of the present disclosure;

FIG. 32 is a perspective view of an electronic device according to the 8th embodiment of the present disclosure;

FIG. 33 is a side view of the electronic device shown in FIG. 32;

FIG. 34 is a top view of the electronic device shown in FIG. 32;

FIG. 35 is a partial cross-sectional view of an anti-reflective film and a substrate of an optical component according to one configuration of the present disclosure under a transmission electron microscope;

FIG. 36 is a distribution map of aluminum elements in the region shown in FIG. 35 analyzed using an energy dispersive x-ray spectrometer;

FIG. 37 is a distribution map of silicon elements in the region shown in FIG. 35 analyzed using an energy dispersive x-ray spectrometer; and

FIG. 38 is a distribution map of titanium elements in the region shown in FIG. 35 analyzed using an energy dispersive x-ray spectrometer.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an optical component, and the optical component has optical applications, such as light-folding, converging, diverging, shielding, or reducing reflection related to optical phenomena, but the present disclosure is not limited to the aforementioned literal descriptions of applications. For example, the optical component can be a lens element or a prism, but the present disclosure is not limited thereto. The optical component includes a substrate and an anti-reflective film, the substrate can be made of, for example, glass material or plastic material, and the anti-reflective film is disposed at least on one or some surfaces of the substrate. The anti-reflective film includes a nanostructure layer and at least one intermediate layer, and the intermediate layer is disposed between the nanostructure layer and substrate.

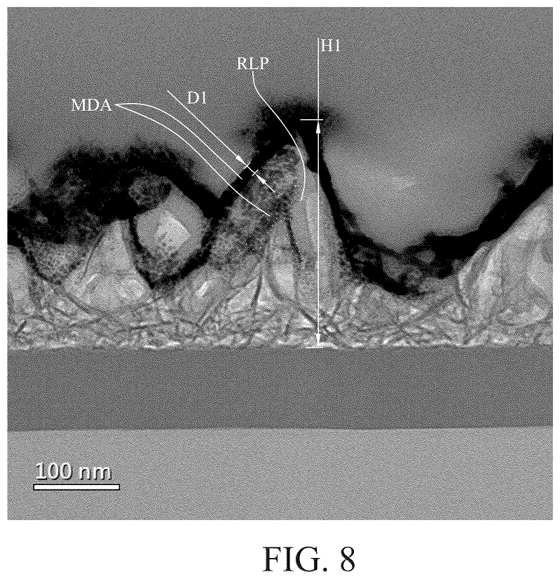

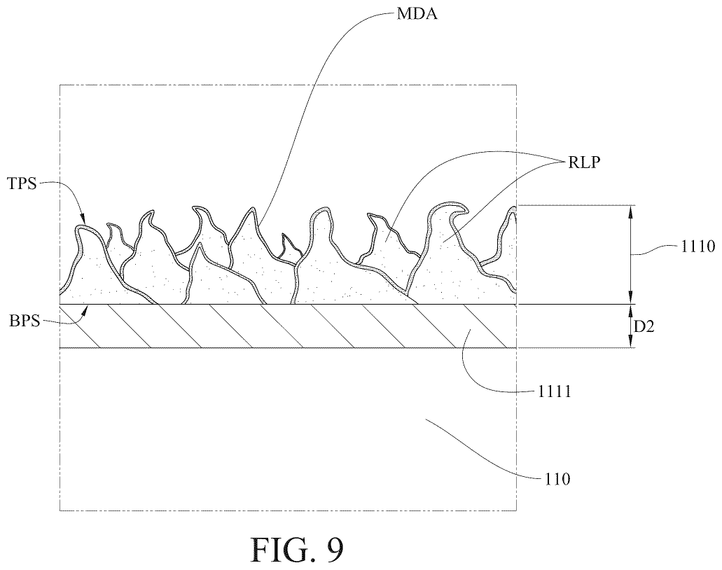

The nanostructure layer includes a plurality of ridge-like protrusions that are non-directionally extended. A bottom of the ridge-like protrusions is located closer to the substrate than a top of the ridge-like protrusions, and the ridge-like protrusions gradually taper from the bottom toward the top. Therefore, the ridge-like protrusions contribute to the formation of a gradient refractive index, thereby reducing reflectance. Moreover, an average structural height of the ridge-like protrusions is greater than 108 nm and less than 368 nm. Moreover, the height of each ridge-like protrusion may be different; therefore, the average structural height of the ridge-like protrusions can be calculated using at least three or more ridge-like protrusions, prioritizing those with identifiable contours. Additionally, the height of a ridge-like protrusion can be defined, from a cross-sectional observation (e.g., destructive measurement), as the vertical height from the absolute bottom of the ridge-like protrusion (e.g., the foot of the ridge) to the top of the ridge-like protrusion (e.g., the peak of the ridge). Please refer to FIG. 8 and FIG. 9, which are schematic views respectively showing the bottom BPS, the top TPS and the average structural height H1 of the ridge-like protrusions RLP and the substrate 110 in the imaging lens according to the 1st embodiment of the present disclosure.

The main component of the nanostructure layer is aluminum oxide (Al₂O₃). The nanostructure layer further includes a metallic doping agent, and at least part of the metallic doping agent is distributed inside the ridge-like protrusions. Therefore, the nanostructure layer containing the metallic doping agent is favorable for increasing the tolerance and durability of the nanostructure layer to environmental changes, reducing the impact of such changes on the film structure and maintaining the performance of the anti-reflective film. Said environmental changes may include variations in temperature, humidity, or other chemical interferences, but the present disclosure is not limited thereto.

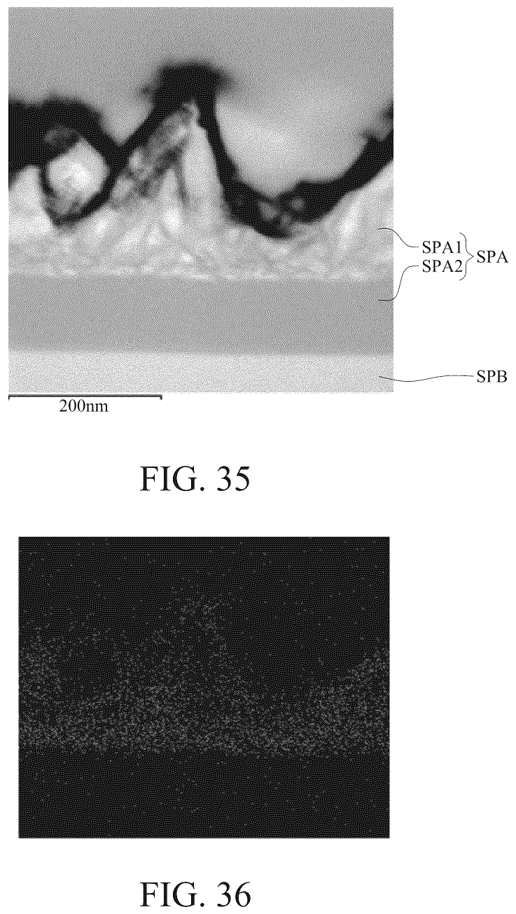

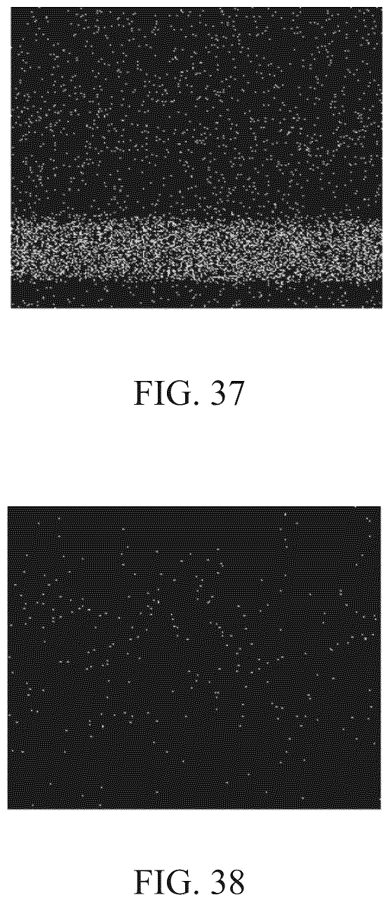

The metallic doping agent includes at least one of titanium, vanadium, chromium, tantalum, zirconium, niobium, titanium oxide, vanadium oxide, chromium oxide, tantalum oxide, zirconium oxide, or niobium oxide. In one aspect, the metallic doping agent is selected from a group consisting of titanium, vanadium, chromium, tantalum, zirconium, niobium, titanium oxide, vanadium oxide, chromium oxide, tantalum oxide, zirconium oxide, and niobium oxide. In one aspect, the metallic doping agent is selected from a group consisting of titanium, vanadium, chromium, titanium oxide, vanadium oxide, and chromium oxide. In one aspect, the main component of the metallic doping agent is titanium oxide. Therefore, it is favorable for increasing the stability of the anti-reflective film. In one aspect, the metallic doping agent is selected from a group consisting of tantalum, zirconium, niobium, tantalum oxide, zirconium oxide, and niobium oxide. Moreover, the detection method for metallic doping agent(s) can be performed using a transmission electron microscope (TEM) equipped with an energy dispersive x-ray spectrometer (EDS) for analysis. Regardless of whether the metallic doping agent exists in the form of metal elements or metal oxides, the distribution of metal species serves as the primary basis for evaluation. For example, please refer to FIG. 35 to FIG. 38. FIG. 35 is a partial cross-sectional view of an anti-reflective film and a substrate of an optical component according to one configuration of the present disclosure under a transmission electron microscope, FIG. 36 is a distribution map of aluminum elements in the region shown in FIG. 35 analyzed using an energy dispersive x-ray spectrometer, FIG. 37 is a distribution map of silicon elements in the region shown in FIG. 35 analyzed using an energy dispersive x-ray spectrometer, and FIG. 38 is a distribution map of titanium elements in the region shown in FIG. 35 analyzed using an energy dispersive x-ray spectrometer. As seen in FIG. 35 to FIG. 38, the transmission electron microscope provides high-resolution images of the microstructure of the anti-reflective film SPA and substrate SPB of the optical component. Additionally, the energy dispersive X-ray spectrometer provides elemental composition information for the anti-reflective film SPA and substrate SPB. This elemental composition information may include, for example, the types of elements and their distribution within the substrate SPB and the nanostructure layer SPA1 and the intermediate layer SPA2 of the anti-reflective film SPA.

In one configuration, the substrate has an aspherical surface, light passes through the aspherical surface, and the anti-reflective film is disposed at least on the aspherical surface. In another configuration, the substrate has a reflection surface configured to reflect light. Moreover, the anti-reflective film can also be disposed on the reflection surface.

In one configuration, the main component of the intermediate layer can be silicon dioxide (SiO₂). Therefore, it is favorable for increasing the connection stability of the anti-reflective film. In another configuration, the main component of the intermediate layer can be the same as one of components that form the nanostructure layer. Therefore, it is favorable for adjusting the gradient refractive index of the anti-reflective film, and also facilitating the connection of the nanostructure layer. Moreover, the main component of the intermediate layer can be, for example, aluminum, titanium, vanadium, chromium, oxides of the aforementioned elements, or combinations thereof, but the present disclosure is not limited thereto.

The number of intermediate layers can be multiple, and the intermediate layers can form thin-film interference, which is favorable for reducing reflectance.

The at least part of the metallic doping agent distributed inside the ridge-like protrusions can gradually taper in a direction away from the substrate. Therefore, the metallic doping agent can also adjust the degree of the gradient refractive index of the nanostructure layer, thereby reducing reflectance.

There can be at least another part of the metallic doping agent distributed on a surface of the ridge-like protrusions. Therefore, it is favorable for protecting the ridge-like protrusions, preventing structural shape changes of the ridge-like protrusions due to environmental variations, thereby maintaining the anti-reflective performance.

A coverage thickness of the metallic doping agent on the surface of the ridge-like protrusions can be greater than 1 nm and less than 40 nm. Therefore, an appropriate thickness condition can preserve the structural shape of the ridge-like protrusions while enhancing the weather resistance of the ridge-like protrusions. Moreover, the coverage thickness of the metallic doping agent on the surface of the ridge-like protrusions can be greater than 1 nm and less than 30 nm. Please refer to FIG. 8, which shows a schematic view of the coverage thickness D1 of the metallic doping agent MDA on the surface of the ridge-like protrusions RLP in the imaging lens according to the 1st embodiment of the present disclosure.

The optical component can further include a matte structure integrally formed with the substrate, and the matte structure can be located on one or some surfaces of the substrate and have an undulating shape (e.g., having continuous convex-concave shapes). Therefore, an undulating surface is favorable for reducing stray light reflections. Moreover, the matte structure can be formed on the substrate of the optical component through mold design. Moreover, the matte structure can be disposed outside an optically active area of the optical component.

The matte structure can have a plurality of protrusion portions, and the protrusion portions can be regularly arranged. Therefore, it is favorable for facilitating the quality control of the matte structure.

The height of the protrusion portions can be greater than 40 μm and less than 1000 μm. Therefore, it is favorable for blocking stray light reflections from reaching the image surface.

The optical component can further include a light-blocking layer located on one or some surfaces of the substrate and configured to block transmission of light. Moreover, the light-blocking layer can be disposed outside the optically active area of the optical component. Therefore, it is favorable for reducing stray light. Moreover, the light-blocking layer can, for example, be composed of materials that reduce light reflection, such as dark ink, photocurable coatings, acrylic pigments, carbon black, or metal oxides, but the present disclosure is not limited thereto. Moreover, the anti-reflective film can be further disposed on the light-blocking layer.

According to the present disclosure, an imaging lens is provided. The imaging lens includes the aforementioned optical component, and an optical axis of the imaging lens passes through the optical component.

According to the present disclosure, an electronic device is provided. The electronic device includes an image sensor and the aforementioned imaging lens, and the image sensor is disposed on an image surface of the imaging lens.

According to the present disclosure, the aforementioned features and conditions can be utilized in numerous combinations so as to achieve corresponding effects.

According to the above description of the present disclosure, the following specific embodiments are provided for further explanation.

### 1st EMBODIMENT

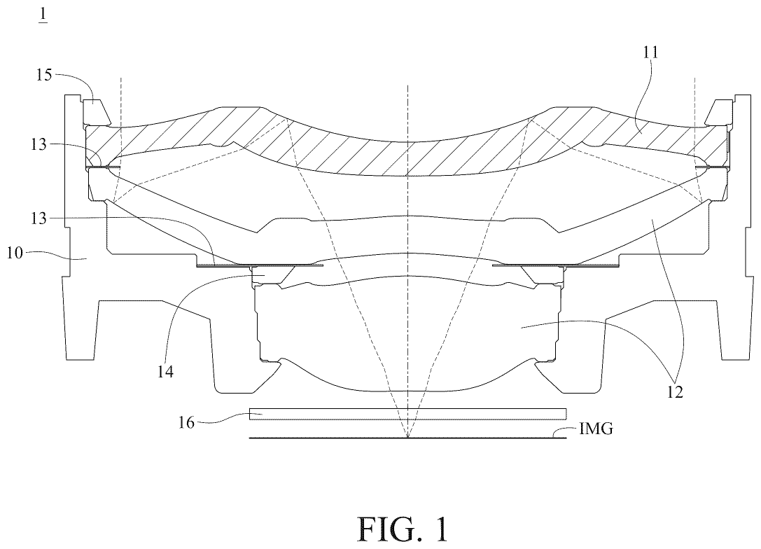

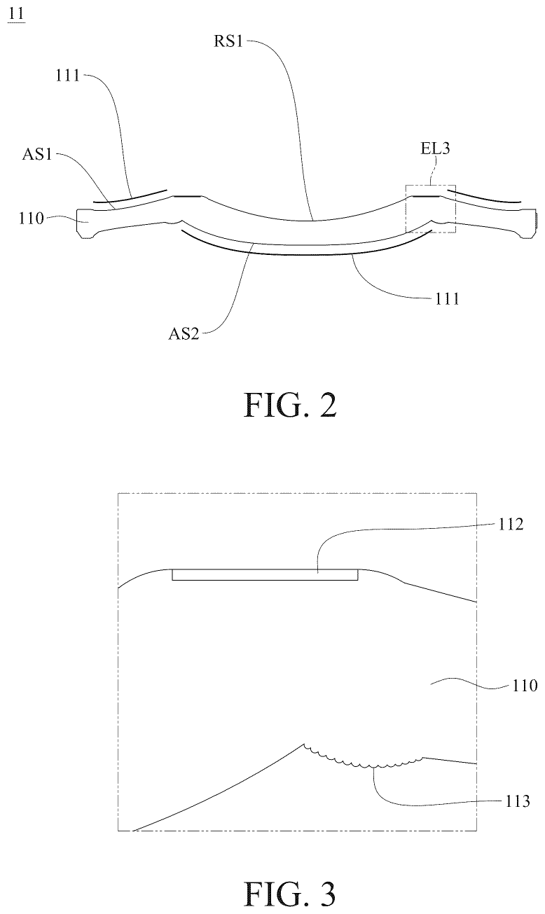

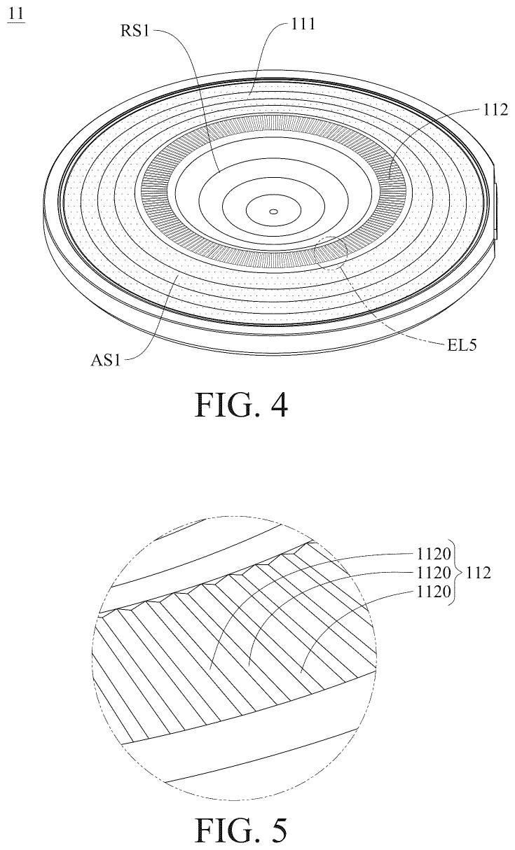

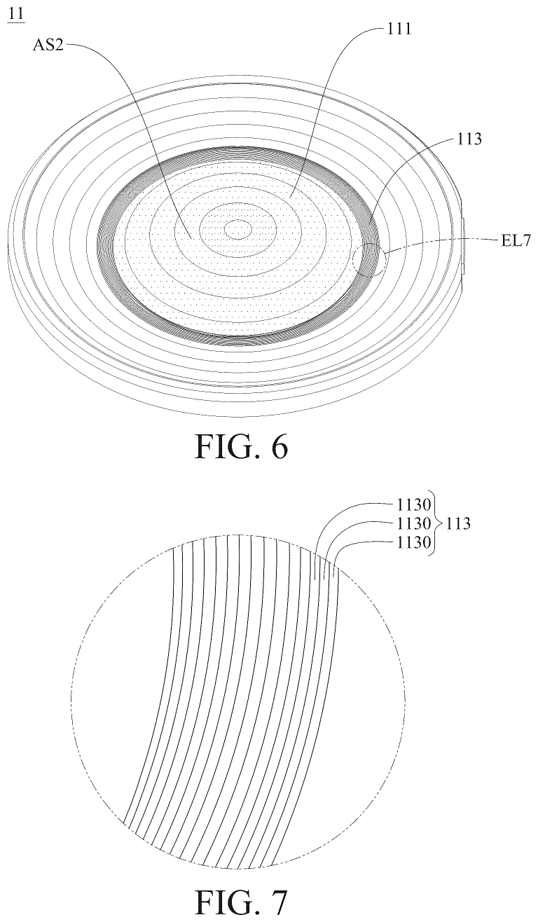

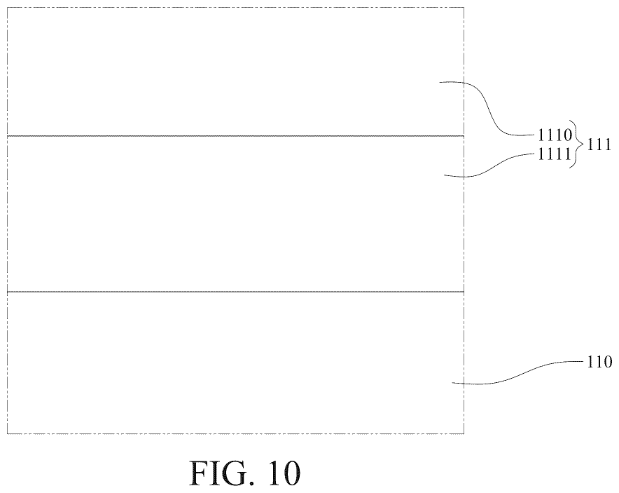

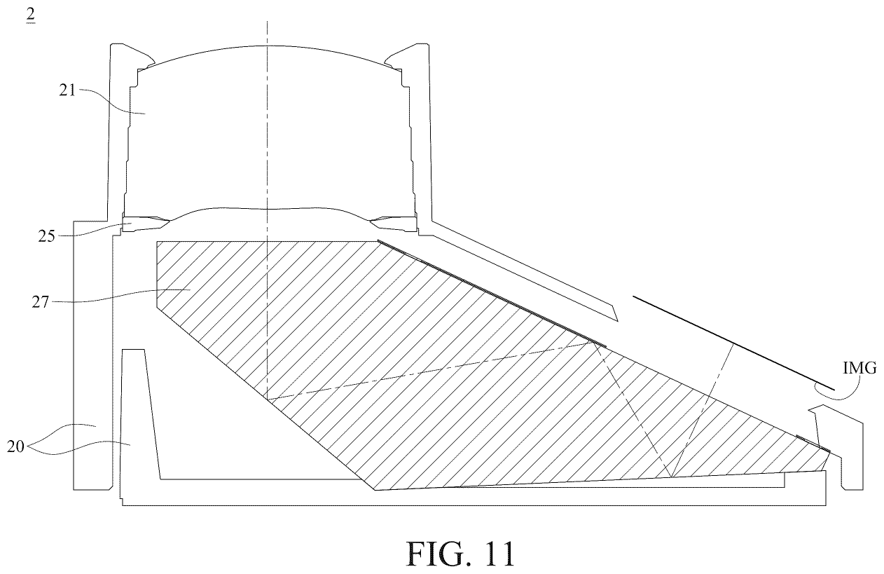

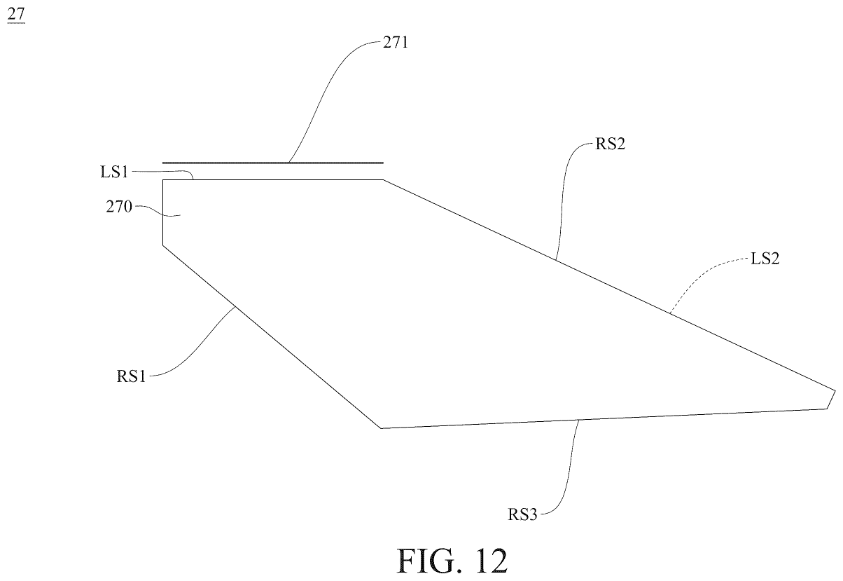

FIG. 1 is a cross-sectional view of an imaging lens according to the 1st embodiment of the present disclosure, FIG. 2 is a cross-sectional view of an optical component of the imaging lens shown in FIG. 1, FIG. 3 is an enlarged view of region EL3 shown in FIG. 2, FIG. 4 is a perspective view of the optical component of the imaging lens shown in FIG. 1, FIG. 5 is an enlarged view of region EL5 shown in FIG. 4, FIG. 6 is another perspective view of the optical component of the imaging lens shown in FIG. 1, FIG. 7 is an enlarged view of region EL7 shown in FIG. 6, FIG. 8 is a partially enlarged cross-sectional view of the optical component of the imaging lens shown in FIG. 1 under a transmission electron microscope, FIG. 9 is a partially enlarged cross-sectional view of the optical component of the imaging lens shown in FIG. 1, and FIG. 10 is a schematic view of the stacking relationship among a nanostructure layer, an intermediate layer and a substrate of the optical component of the imaging lens shown in FIG. 1.

An imaging lens 1 is provided in this embodiment. The imaging lens 1 is a telephoto imaging lens, and the imaging lens 1 includes a plurality of optical components and an image surface IMG. The optical components include a barrel 10, a plurality of lens elements 11 and 12, a plurality of light-blocking elements 13, a spacer 14, a retainer 15 and a filter 16. Moreover, the lens elements 11 and 12, the light-blocking elements 13, the spacer 14 and the retainer 15 are accommodated in the barrel 10, the filter 16 is disposed between the lens element 12 and the image surface IMG, and an optical axis of the imaging lens 1 passes through the optical components. After entering the barrel 10, the light passes through the lens elements 11 and 12, the light-blocking elements 13 and the filter 16, becoming imaging light that forms an image on the image surface IMG.

The lens element 11 includes a substrate 110, two anti-reflective films 111 and two matte structures 112 and 113. The substrate 110 has two aspherical surfaces AS1 and AS2 and a reflection surface RS1, light passes through the aspherical surfaces AS1 and AS2, and the reflection surface RS1 is configured to reflect light. The anti-reflective films 111 are disposed on the aspherical surfaces AS1 and AS2. Note that in FIG. 2, the anti-reflective films 111 are illustrated as separated from the substrate 110 solely for clear expression. However, the connection between the anti-reflective films 111 and the substrate 110 is not limited to the depiction shown in the figure.

As shown in FIG. 9 and FIG. 10, each of the anti-reflective films 111 includes a nanostructure layer 1110 and an intermediate layer 1111, and the intermediate layer 1111 is disposed between the nanostructure layer 1110 and the substrate 110.

The main component of the nanostructure layer 1110 is aluminum oxide, and the main component of the intermediate layer 1111 is silicon dioxide. In addition, the nanostructure layer 1110 includes a plurality of ridge-like protrusions RLP that are non-directionally extended and a plurality of metallic doping agents MDA. As shown in FIG. 9, a bottom BPS of the ridge-like protrusions RLP is located closer to the substrate 110 than a top TPS of the ridge-like protrusions RLP, and the ridge-like protrusions RLP gradually taper from the bottom BPS to the top TPS.

The main component of the metallic doping agents MDA is titanium oxide, and at least part of the metallic doping agents MDA is distributed inside the ridge-like protrusions RLP and at least another part of the metallic doping agents MDA is distributed on a surface of the ridge-like protrusions RLP. Moreover, the at least part of the metallic doping agents MDA distributed inside the ridge-like protrusions RLP gradually tapers in a direction away from the substrate 110.

The matte structures 112 and 113 are integrally formed with the substrate 110, and the matte structures 112 and 113 are located on surface(s) of the substrate 110 and disposed outside an optically active area of the lens element 11. Moreover, each of the matte structures 112 and 113 has an undulating shape. Specifically, as shown in FIG. 2 to FIG. 5, the matte structure 112 is located on an object-side surface of the substrate 110, and the matte structure 112 has a plurality of protrusion portions 1120 that are regularly arranged. Additionally, the protrusion portions 1120 are each in a triangular shape, and the height of the protrusion portions 1120 is 75 μm. As shown in FIG. 2, FIG. 3, FIG. 6 and FIG. 7, the matte structure 113 is located on an image-side surface of the substrate 110, and the matte structure 113 has a plurality of curved protrusion portions 1130 that are regularly arranged. Additionally, the curved protrusion portions 1130 are arranged as concentric circles on the surface of the substrate 110, and the height of the curved protrusion portions 1130 is 50 μm.

As shown in FIG. 8, an average structural height H1 of the ridge-like protrusions RLP is 266.2 nm.

As shown in FIG. 8, a coverage thickness D1 of the metallic doping agents MDA on the surface of the ridge-like protrusions RLP is 12.6 nm.

As shown in FIG. 9 and FIG. 10, the number of the intermediate layer 1111 is one, and a thickness D2 of the intermediate layer 1111 is 92.85 nm.

### 2nd EMBODIMENT

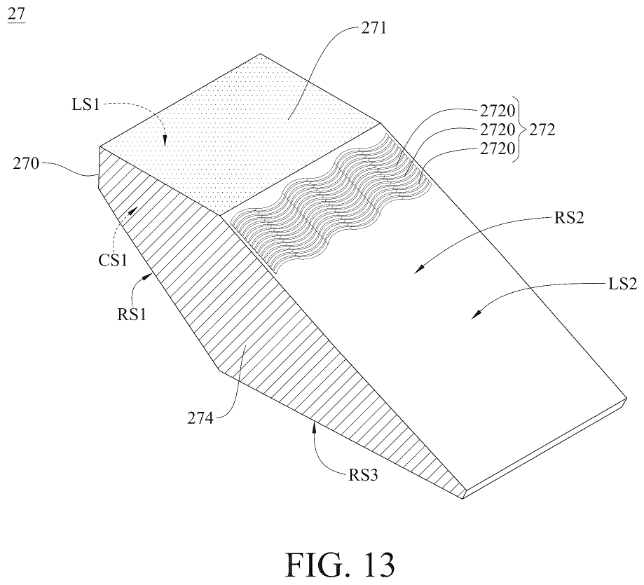

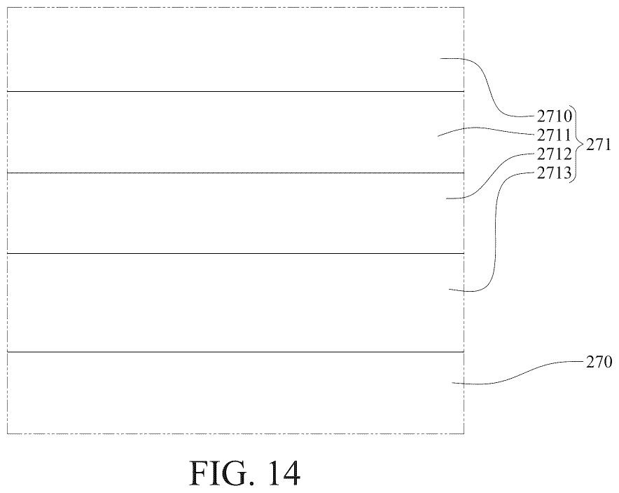

FIG. 11 is a cross-sectional view of an imaging lens according to the 2nd embodiment of the present disclosure, FIG. 12 is a cross-sectional view of an optical component of the imaging lens shown in FIG. 11, FIG. 13 is a perspective view of the optical component of the imaging lens shown in FIG. 11, and FIG. 14 is a schematic view of the stacking relationship among a nanostructure layer, three intermediate layers and a substrate of the optical component of the imaging lens shown in FIG. 11.

An imaging lens 2 is provided in this embodiment. The imaging lens 2 is a telephoto imaging lens, and the imaging lens 2 includes a plurality of optical components and an image surface IMG. The optical components include a barrel 20, a lens assembly 21, a retainer 25 and a prism 27. Moreover, the lens assembly 21, the retainer 25 and the prism 27 are accommodated in the barrel 20, and an optical axis of the imaging lens 2 passes through the optical components. After entering the barrel 20, the light passes through the lens assembly 21 and the prism 27, becoming imaging light that forms an image on the image surface IMG. Note that the components inside the barrel 20 are not limited to the shapes illustrated in the figures.

The prism 27 includes a substrate 270, an anti-reflective film 271, a matte structure 272 and at least one light-blocking layer 274. The substrate 270 has a light incident surface LS1, three reflection surfaces RS1, RS2 and RS3 and a light exit surface LS2, and the reflection surfaces RS1, RS2 and RS3 are configured to reflect light. The anti-reflective film 271 is disposed on the light incident surface LS1 of the substrate 270. Note that in FIG. 12, the anti-reflective film 271 is illustrated as separated from the substrate 270 solely for clear expression. However, the connection between the anti-reflective film 271 and the substrate 270 is not limited to the depiction shown in the figure.

As shown in FIG. 14, the anti-reflective film 271 includes a nanostructure layer 2710 and three intermediate layers 2711, 2712 and 2713, and the intermediate layers 2711, 2712 and 2713 are disposed between the nanostructure layer 2710 and the substrate 270.

The main component of the nanostructure layer 2710 is aluminum oxide, and the nanostructure layer 2710 includes a plurality of ridge-like protrusions non-directionally extended and a plurality of metallic doping agents. A bottom of the ridge-like protrusions is located closer to the substrate 270 than a top of the ridge-like protrusions, and the ridge-like protrusions gradually taper from the bottom to the top. The metallic doping agents includes at least one of titanium, vanadium, chromium, tantalum, zirconium, niobium, titanium oxide, vanadium oxide, chromium oxide, tantalum oxide, zirconium oxide, or niobium oxide, and at least part of the metallic doping agents is distributed inside the ridge-like protrusions.

The main component of the intermediate layer 2711 is silicon dioxide, the main component of the intermediate layer 2712 is aluminum oxide, and the main component of the intermediate layer 2713 is titanium oxide. Moreover, the main components of the intermediate layer 2712 and the intermediate layer 2713 are the same as one of components that form the nanostructure layer 2710.

The matte structure 272 is integrally formed with the substrate 270, and the matte structure 272 is located on the surface of the substrate 270 and disposed outside an optically active area of the prism 27. Moreover, the matte structure 272 has an undulating shape. Specifically, as shown in FIG. 12 and FIG. 13, the matte structure 272 is disposed on the surface of the substrate 270 adjacent to reflection surface RS2, and the matte structure 272 has a plurality of curved protrusion portions 2720 that are regularly arranged. The curved protrusion portions 2720 extend along an S-shaped path on the surface of the substrate 270, and a height of the curved protrusion portions 2720 is 300 μm.

The light-blocking layer 274 is located on a connection surface CS1 of the substrate 270 and configured to block transmission of light. Moreover, the connection surface CS1 is connected to the light incident surface LS1, the reflection surfaces RS1, RS2 and RS3 and the light exit surface LS2.

An average structural height of the ridge-like protrusions is greater than 108 nm and less than 368 nm.

As shown in FIG. 14, the number of the intermediate layers 2711, 2712 and 2713 is three. A thickness D21 of the intermediate layer 2711 is 12.6 nm, a thickness D22 of the intermediate layer 2712 is 37.2 nm, and a thickness D23 of the intermediate layer 2713 is 19.4 nm.

### 3rd EMBODIMENT

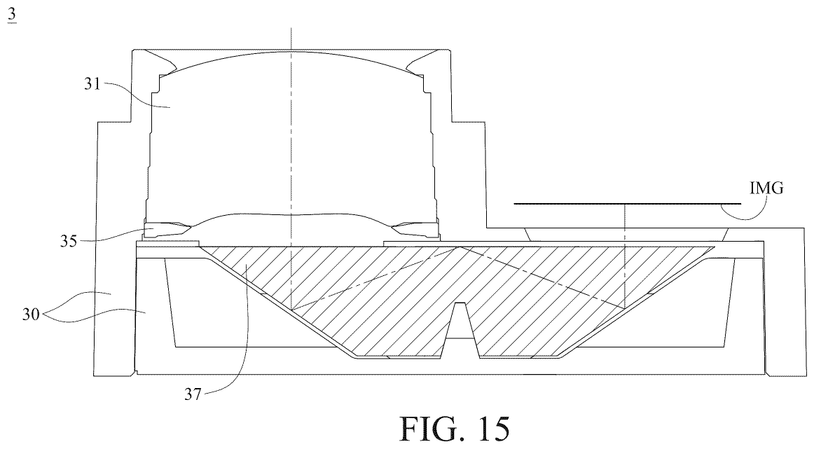

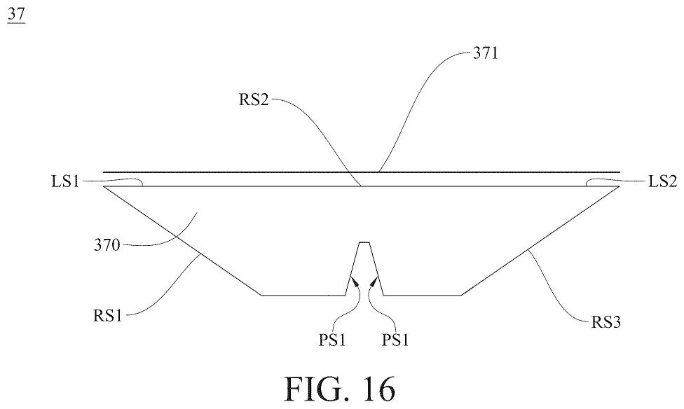

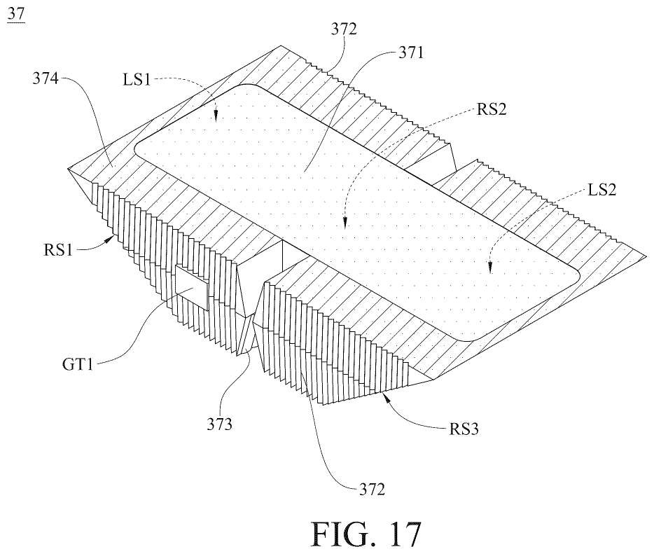

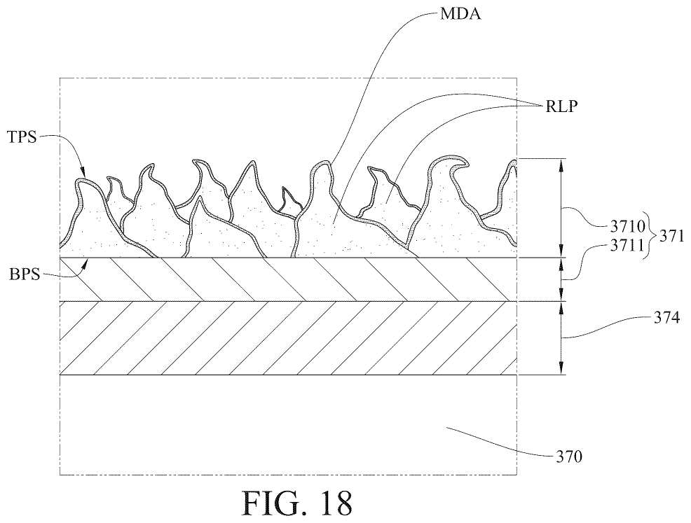

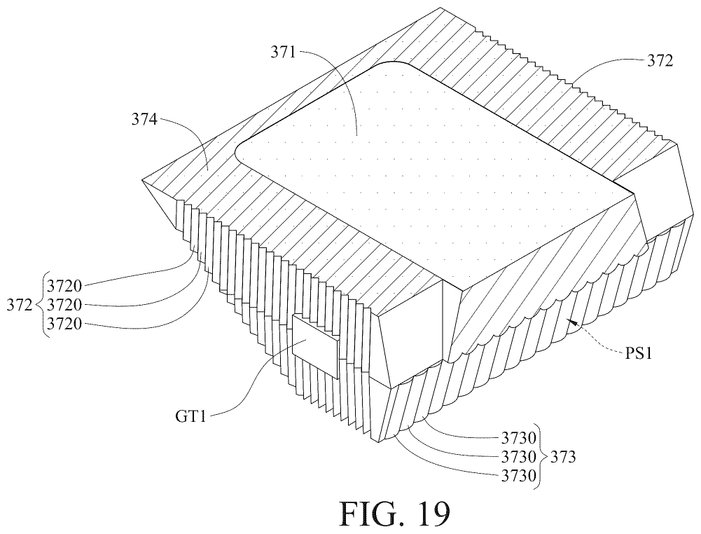

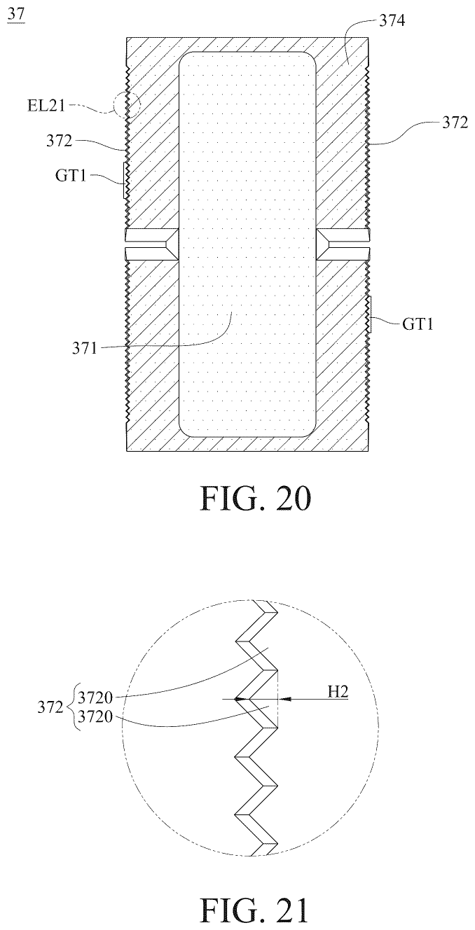

FIG. 15 is a cross-sectional view of an imaging lens according to the 3rd embodiment of the present disclosure, FIG. 16 is a cross-sectional view of an optical component of the imaging lens shown in FIG. 15, FIG. 17 is a perspective view of the optical component of the imaging lens shown in FIG. 15, FIG. 18 is a partially enlarged cross-sectional view of the optical component of the imaging lens shown in FIG. 15, FIG. 19 is a sectional view of the optical component shown in FIG. 17, FIG. 20 is a top view of the optical component shown in FIG. 17, and FIG. 21 is an enlarged view of region EL21 shown in FIG. 20.

An imaging lens 3 is provided in this embodiment. The imaging lens 3 is a telephoto imaging lens, and the imaging lens 3 includes a plurality of optical components and an image surface IMG. The optical components include a barrel 30, a lens assembly 31, a retainer 35 and a prism 37. Moreover, the lens assembly 31, the retainer 35 and the prism 37 are accommodated in the barrel 30, and an optical axis of the imaging lens 3 passes through the optical components. After entering the barrel 30, the light passes through the lens assembly 31 and the prism 37, becoming imaging light that forms an image on the image surface IMG. Note that the components inside the barrel 30 are not limited to the shapes illustrated in the figures.

The prism 37 includes a substrate 370, an anti-reflective film 371, a plurality of matte structures 372 and 373 and a light-blocking layer 374. The substrate 370 has a light incident surface LS1, three reflection surfaces RS1, RS2 and RS3 and a light exit surface LS2, and the reflection surfaces RS1, RS2 and RS3 are configured to reflect light. Moreover, the reflection surface RS2 can reflect light through a high-reflective coating or total reflection principles. The anti-reflective film 371 is disposed on the light incident surface LS1, the reflection surface RS2 and the light exit surface LS2 of the substrate 370. Note that in FIG. 16, the anti-reflective film 371 is illustrated as separated from the substrate 370 solely for clear expression. However, the connection between the anti-reflective film 371 and the substrate 370 is not limited to the depiction shown in the figure.

As shown in FIG. 18, the anti-reflective film 371 includes a nanostructure layer 3710 and an intermediate layer 3711, and the intermediate layer 3711 is disposed between the nanostructure layer 3710 and the substrate 370.

The main component of the nanostructure layer 3710 is aluminum oxide, and the nanostructure layer 3710 includes a plurality of the ridge-like protrusions RLP that are non-directionally extended and a plurality of the metallic doping agents MDA. A bottom BPS of the ridge-like protrusions RLP is located closer to the substrate 370 than a top TPS of the ridge-like protrusions RLP, and the ridge-like protrusions RLP gradually taper from the bottom BPS to the top TPS.

The main component of the metallic doping agents MDA is titanium oxide, and at least part of the metallic doping agents MDA is distributed inside the ridge-like protrusions RLP and at least another part of the metallic doping agents MDA is distributed on a surface of the ridge-like protrusions RLP. Moreover, the at least part of the metallic doping agents MDA distributed inside the ridge-like protrusions RLP gradually tapers in a direction away from the substrate 370.

The main component of the intermediate layer 3711 is aluminum, titanium, vanadium, chromium, oxides of the aforementioned elements, silicon dioxide or combinations thereof, and the main component of the intermediate layer 3711 is the same as one of components that form the nanostructure layer 3710.

The matte structures 372 and 373 are integrally formed with the substrate 370, and the matte structures 372 and 373 are located on one or some surfaces of the substrate 370 and disposed outside an optically active area of the prism 37. Moreover, the matte structures 372 and 373 each have an undulating shape. Specifically, as shown in FIG. 17 and FIG. 19 to FIG. 21, the matte structure 372 is disposed on the connection surface CS1 of the substrate 370, and the matte structure 372 has a plurality of triangular protrusion portions 3720 that are regularly arranged. A height H2 of the triangular protrusion portions 3720 is 100 μm. Moreover, the connection surface CS1 is connected to the light incident surface LS1, the reflection surfaces RS1, RS2 and RS3 and the light exit surface LS2. Furthermore, the matte structure 373 is disposed on a recess surface PS1 of the substrate 370, and the matte structure 373 has a plurality of curved protrusion portions 3730 that are regularly arranged. A height of the curved protrusion portions 3730 is 150 μm.

The light-blocking layer 374 is located on some surfaces of the substrate 370 and configured to block transmission of light. Specifically, as shown in FIG. 17, the light-blocking layer 374 is disposed on surfaces of the substrate 370 adjacent to the light incident surface LS1, the reflection surface RS2 and the light exit surface LS2, and located outside the optically active area of the prism 37. Furthermore, as shown in FIG. 18, a part of the anti-reflective film 371 is further disposed on the light-blocking layer 374, such that a part of the light-blocking layer 374 is located between the anti-reflective film 371 and the substrate 370.

An average structural height of the ridge-like protrusions RLP is greater than 108 nm and less than 368 nm. A coverage thickness of the metallic doping agents MDA on the surface of the ridge-like protrusions RLP is greater than 1 nm and less than 40 nm.

As shown in FIG. 18, the number of the intermediate layer 3711 is one. Furthermore, as shown in FIG. 17, FIG. 19 and FIG. 20, the prism 37 has a plurality of gate traces GT1 at suitable positions to provide better molding efficiency for the prism 37.

### 4th EMBODIMENT

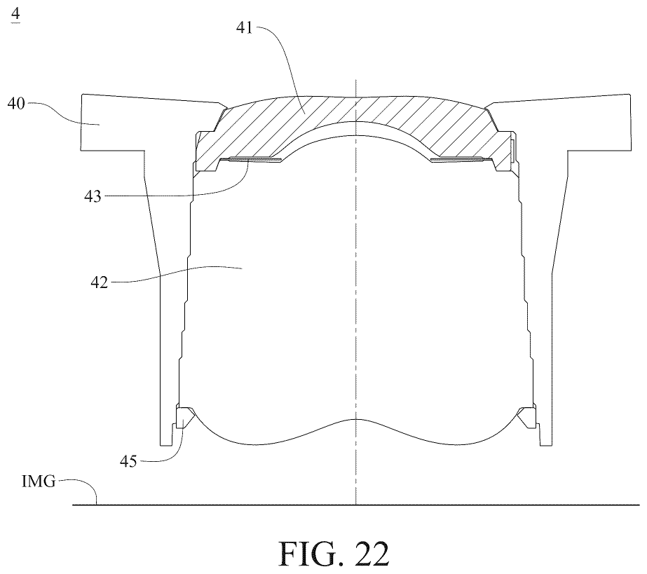

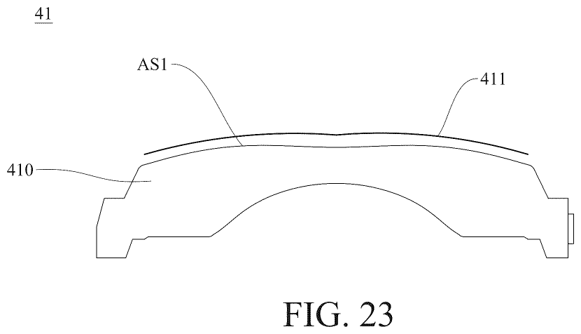

FIG. 22 is a cross-sectional view of an imaging lens according to the 4th embodiment of the present disclosure, and FIG. 23 is a cross-sectional view of an optical component of the imaging lens shown in FIG. 22. In this embodiment, an imaging lens 4 is similar to the imaging lens 1 of the 1st embodiment as described above. The same or similar reference numerals indicate the same or similar components, and functions and effects provided by those components are the same as described above, so an explanation in this regard will not be provided again.

The imaging lens 4 is an ultra-wide-angle imaging lens, and the imaging lens 4 includes a plurality of optical components and an image surface IMG. The optical components include a barrel 40, a plurality of lens elements 41 and 42, a light-blocking element 43 and a retainer 45. Moreover, the lens elements 41 and 42, the light-blocking element 43 and the retainer 45 are accommodated in the barrel 40, and an optical axis of the imaging lens 4 passes through the optical components. After entering the barrel 40, the light passes through the lens elements 41 and 42 and the light-blocking element 43, becoming imaging light that forms an image on the image surface IMG.

The lens element 41 includes a substrate 410 and an anti-reflective film 411. The substrate 410 has an aspherical surface AS1, and light passes through the aspherical surface AS1. The anti-reflective film 411 is disposed on the aspherical surface AS1. Note that in FIG. 23, the anti-reflective film 411 is illustrated as separated from the substrate 410 solely for clear expression. However, the connection between the anti-reflective film 411 and the substrate 410 is not limited to the depiction shown in the figure. Moreover, the components inside the barrel 40 are not limited to the shapes illustrated in the figures.

### 5th EMBODIMENT

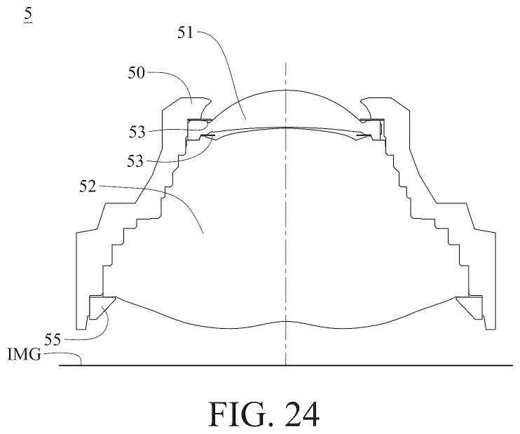

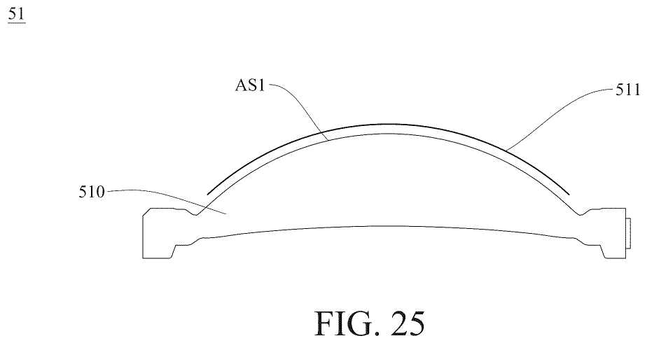

FIG. 24 is a cross-sectional view of an imaging lens according to the 5th embodiment of the present disclosure, and FIG. 25 is a cross-sectional view of an optical component of the imaging lens shown in FIG. 24.

An imaging lens 5 is provided in this embodiment. The imaging lens 5 is a wide-angle imaging lens, and the imaging lens 5 includes a plurality of optical components and an image surface IMG. The optical components include a barrel 50, a plurality of lens elements 51 and 52, a plurality of light-blocking elements 53 and a retainer 55. Moreover, the lens elements 51 and 52, the light-blocking elements 53 and the retainer 55 are accommodated in the barrel 50, and an optical axis of the imaging lens 5 passes through the optical components. After entering the barrel 50, the light passes through the lens elements 51 and 52 and the light-blocking elements 53, becoming imaging light that forms an image on the image surface IMG.

The lens element 51 includes a substrate 510 and an anti-reflective film 511. The substrate 510 has an aspherical surface AS1, and light passes through the aspherical surface AS1. The anti-reflective film 511 is disposed on the aspherical surface AS1. Note that in FIG. 25, the anti-reflective film 511 is illustrated as separated from the substrate 510 solely for clear expression. However, the connection between the anti-reflective film 511 and the substrate 510 is not limited to the depiction shown in the figure. Moreover, the components inside the barrel 50 are not limited to the shapes illustrated in the figures.

### 6th EMBODIMENT

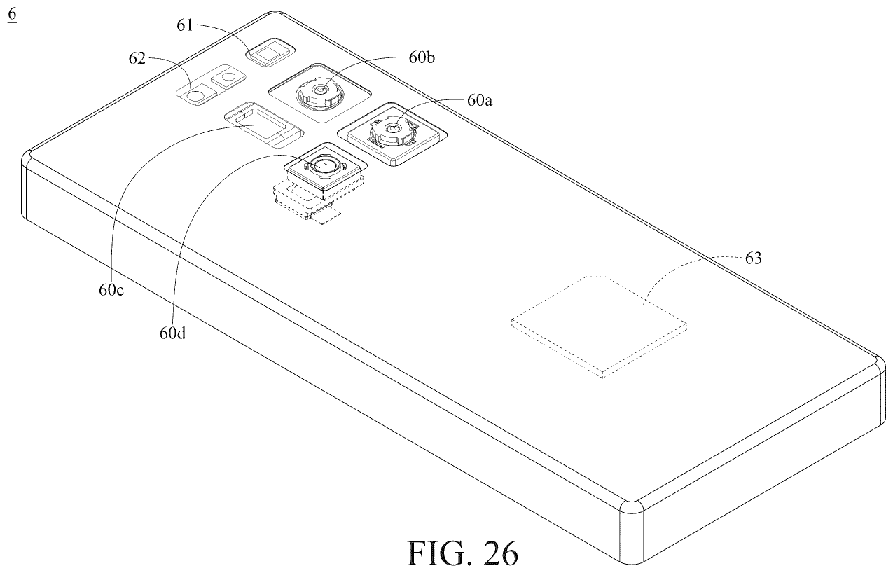

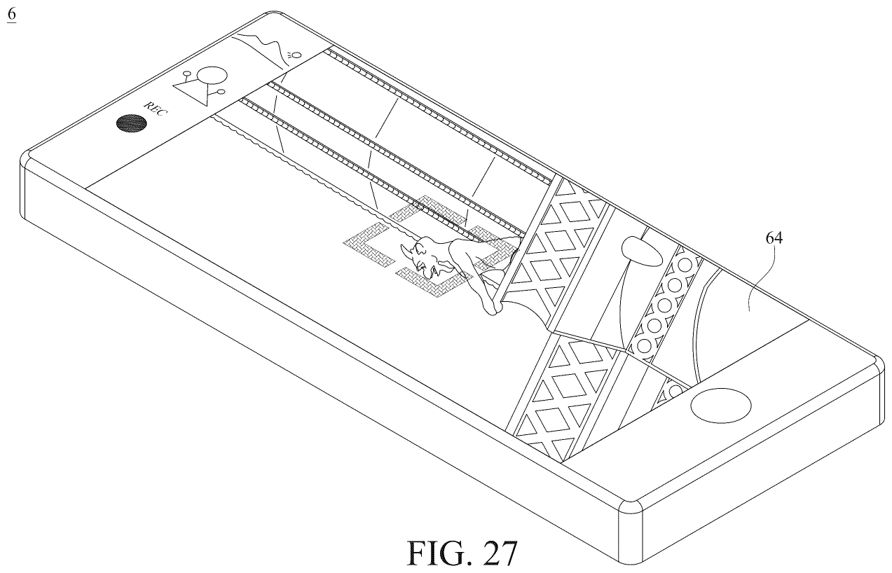

FIG. 26 is a perspective view of an electronic device according to the 6th embodiment of the present disclosure, and FIG. 27 is another perspective view of the electronic device in shown FIG. 26.

In this embodiment, the electronic device 6 is a smartphone including a plurality of imaging lenses, a flash module 61, a focus assist module 62, an image signal processor 63, a display module (user interface) 64, an image software processor (not shown) and an image sensor (not shown).

These imaging lenses includes an ultra-wide-angle imaging lens 60a, a high pixel imaging lens 60b, a telephoto imaging lens 60c and a telephoto imaging lens 60d. Moreover, the imaging lens 60a includes, for example, the imaging lens 4 of the 4th embodiment as described above, the imaging lens 60c includes, for example, the imaging lens 2 of the 2nd embodiment or the imaging lens 3 of the 3rd embodiment as described above, and the imaging lens 60d includes, for example, the imaging lens 1 of the 1st embodiment as described above. The image sensor is disposed on the image surface of the imaging lenses 60a, 60b, 60c and 60d.

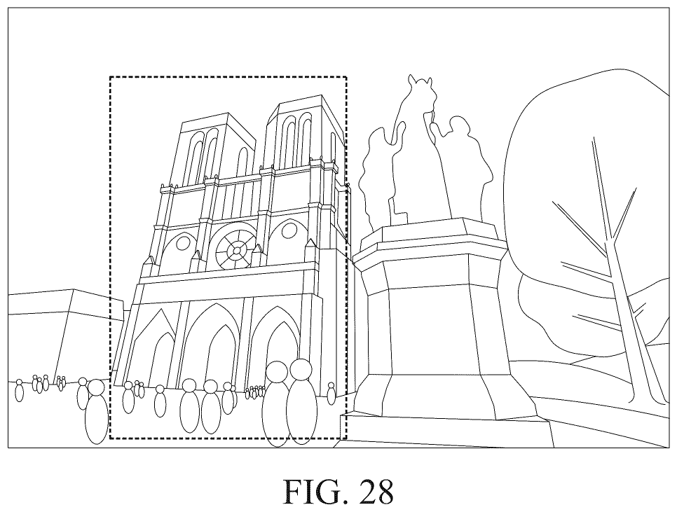

The image captured by the ultra-wide-angle imaging lens 60a enjoys a feature of multiple imaged objects. FIG. 28 is an image captured by the ultra-wide-angle imaging lens 60a.

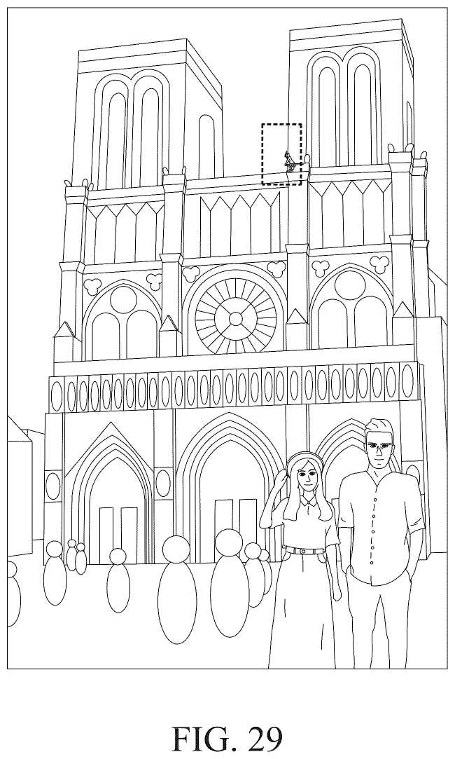

The image captured by the high pixel imaging lens 60b enjoys a feature of high resolution and less distortion, and the high pixel imaging lens 60b can capture part of the image in FIG. 28. FIG. 29 is an image captured by the high pixel imaging lens 60b.

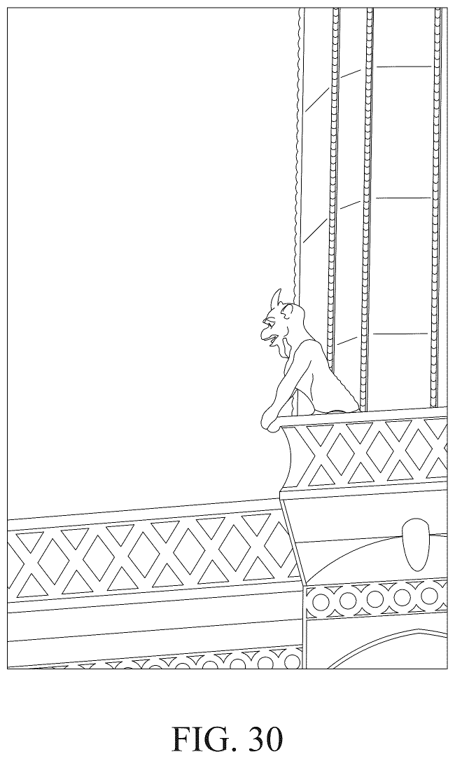

The image captured by the telephoto imaging lens 60c or 60d enjoys a feature of high optical magnification, and the imaging lens 60c or 60d can capture part of the image in FIG. 29. FIG. 30 is an image captured by the telephoto imaging lens 60c or 60d. Moreover, the maximum field of view of the imaging lens corresponds to the field of view in FIG. 30.

When a user captures images of an object, the light rays converge in the ultra-wide-angle imaging lens 60a, the high pixel imaging lens 60b, the telephoto imaging lens 60c or the telephoto imaging lens 60d to generate images, and the flash module 61 is activated for light supplement. The focus assist module 62 detects the object distance of the imaged object to achieve fast auto focusing. The image signal processor 63 is configured to optimize the captured image to improve image quality and provided zooming function. The light beam emitted from the focus assist module 62 can be either conventional infrared or laser. The display module 64 can include a touch screen, and the user is able to interact with the display module 64 to adjust the angle of view and switch between different imaging lenses, and the image software processor having multiple functions to capture images and complete image processing. Alternatively, the user may capture images via a physical button. The image processed by the image software processor can be displayed on the display module 64.

### 7th EMBODIMENT

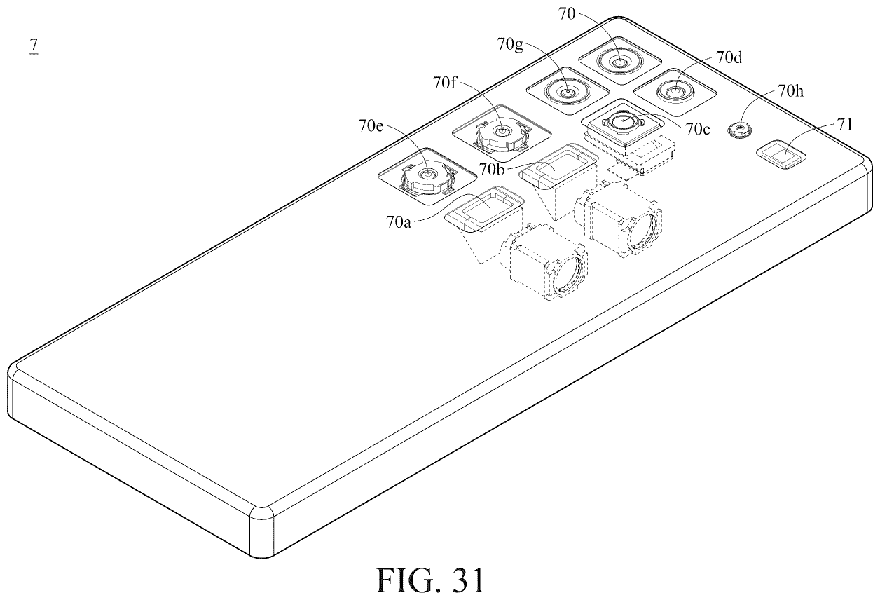

FIG. 31 is a perspective view of an electronic device according to the 7th embodiment of the present disclosure.

In this embodiment, the electronic device 7 is a smartphone including an imaging lens 70, an imaging lens 70a, an imaging lens 70b, an imaging lens 70c, an imaging lens 70d, an imaging lens 70e, an imaging lens 70f, an imaging lens 70g, an imaging lens 70h, a flash module 71, an image signal processor, a display module, an image software processor (not shown) and an image sensor (not shown). The imaging lens 70, the imaging lens 70a, the imaging lens 70b, the imaging lens 70c, the imaging lens 70d, the imaging lens 70e, the imaging lens 70f, the imaging lens 70g and the imaging lens 70h are disposed on the same side of the electronic device 7, while the display module is disposed on the opposite side of the electronic device 7. Moreover, the imaging lens 70d includes, for example, the imaging lens 1 of the 1st embodiment as described above, the imaging lens 70c includes, for example, the imaging lens 2 of the 2nd embodiment or the imaging lens 3 of the 3rd embodiment as described above, the imaging lens 70 and the imaging lens 70g each include the imaging lens 4 of the 4th embodiment as described above, and the imaging lens 70e and the imaging lens 70f each include the imaging lens 5 of the 5th embodiment as described above. The image sensor is disposed on the image surface of the imaging lenses 70, 70a, 70b, 70c, 70d, 70e, 70f, 70g and 70h.

The imaging lens 70 is an ultra-wide-angle imaging lens, the imaging lens 70a is a telephoto imaging lens, the imaging lens 70b is a telephoto imaging lens, the imaging lens 70c is a telephoto imaging lens, the imaging lens 70d is a telephoto imaging lens, the imaging lens 70e is a wide-angle imaging lens, the imaging lens 70f is a wide-angle imaging lens, the imaging lens 70g is an ultra-wide-angle imaging lens, and the imaging lens 70h is a ToF (time of flight) imaging lens. In this embodiment, the imaging lens 70, the imaging lens 70a, the imaging lens 70b, the imaging lens 70c, the imaging lens 70d, the imaging lens 70e, the imaging lens 70f and the imaging lens 70g have different fields of view, such that the electronic device 7 can have various magnification ratios so as to meet the requirement of optical zoom functionality. In addition, the imaging lens 70a and the imaging lens 70b are each a telephoto imaging lens with a light-folding element configuration. In addition, the imaging lens 70h can determine depth information of the imaged object. In this embodiment, the electronic device 7 includes multiple imaging lenses 70, 70a, 70b, 70c, 70d, 70e, 70f, 70g, and 70h, but the present disclosure is not limited to the number and arrangement of imaging lenses. When a user captures images of an object, the light rays converge in the imaging lens 70, the imaging lens 70a, the imaging lens 70b, the imaging lens 70c, the imaging lens 70d, the imaging lens 70e, the imaging lens 70f, the imaging lens 70g or the imaging lens 70h to generate an image(s), and the flash module 71 is activated for light supplement. Further, the subsequent processes are performed in a manner similar to the abovementioned embodiments, so the details in this regard will not be provided again.

### 8th EMBODIMENT

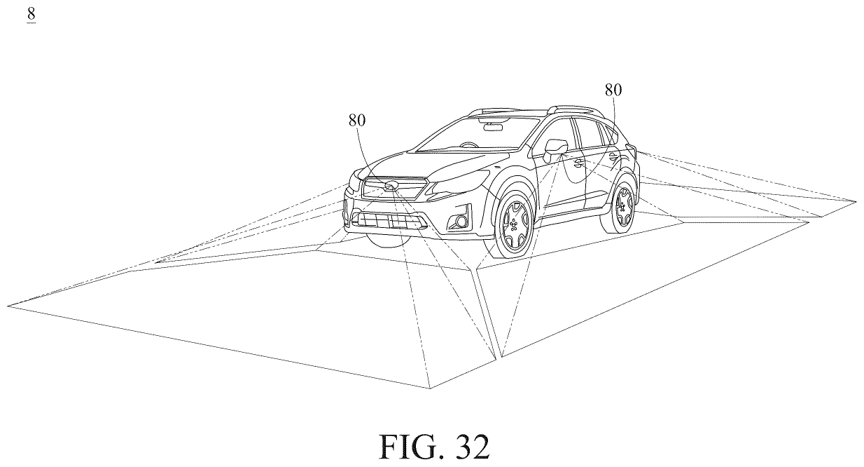

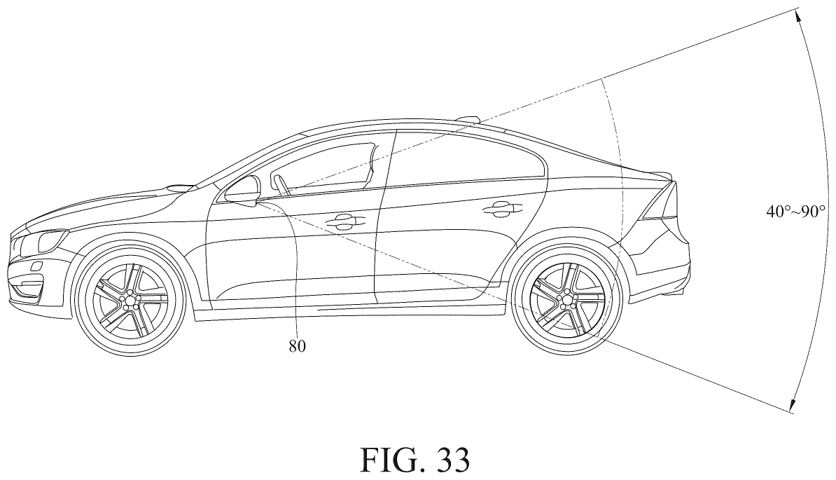

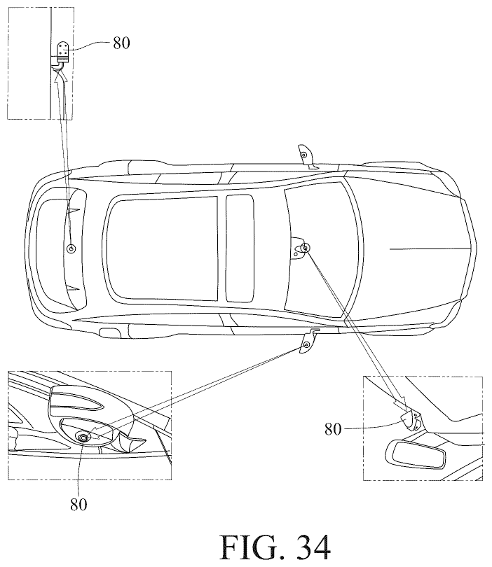

FIG. 32 is a perspective view of an electronic device according to the 8th embodiment of the present disclosure, FIG. 33 is a side view of the electronic device shown in FIG. 32, and FIG. 34 is a top view of the electronic device shown in FIG. 32.

In this embodiment, the electronic device 8 is an automobile. The electronic device 8 includes a plurality of automotive imaging lenses 80, and the imaging lenses 80 each include the imaging lens of the present disclosure. The imaging lenses 80 can serve as, for example, panoramic view car cameras, dashboard cameras and vehicle backup cameras.

As shown in FIG. 32, the imaging lenses 80 are, for example, disposed around the automobile to capture peripheral images of the automobile, which is favorable for obtaining external traffic information so as to achieve autopilot function. In addition, the image software processor may stitch the peripheral images into one panoramic view image for the driver's checking every corner surrounding the automobile, thereby favorable for parking and driving.

As shown in FIG. 33, the imaging lenses 80 are, for example, respectively disposed on the lower portion of the side mirrors. A maximum field of view of the imaging lenses 80 can be 40 degrees to 90 degrees for capturing images in regions on left and right lanes.

As shown in FIG. 34, the imaging lenses 80 can also be, for example, respectively disposed on the lower portion of the side mirrors and inside the front and rear windshields for providing external information to the driver, and also providing more viewing angles so as to reduce blind spots, thereby improving driving safety.

The smartphones, panoramic view car cameras, dashboard cameras and vehicle backup cameras in the embodiments are only exemplary for showing the optical component and the imaging lens of the present disclosure installed in an electronic device, and the present disclosure is not limited thereto. The optical component and the imaging lens can be optionally applied to optical systems with a movable focus. Furthermore, the imaging lens features good capability in aberration corrections and high image quality, and can be applied to 3D (three-dimensional) image capturing applications, in products such as digital cameras, mobile devices, digital tablets, smart televisions, network surveillance devices, multi-camera devices, image recognition systems, motion sensing input devices, wearable devices and other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical component comprising:
a substrate having an aspherical surface, wherein light passes through the aspherical surface; and
an anti-reflective film disposed at least on the aspherical surface, and the anti-reflective film comprising:
a nanostructure layer comprising a plurality of ridge-like protrusions that are non-directionally extended, wherein a bottom of the plurality of ridge-like protrusions is located closer to the substrate than a top of the plurality of ridge-like protrusions, the plurality of ridge-like protrusions gradually taper from the bottom toward the top, and an average structural height of the plurality of ridge-like protrusions is greater than 108 nm and less than 368 nm; and
at least one intermediate layer disposed between the nanostructure layer and the substrate;
wherein a main component of the nanostructure layer is aluminum oxide, the nanostructure layer further comprises a metallic doping agent, at least part of the metallic doping agent is distributed inside the plurality of ridge-like protrusions, and the metallic doping agent comprises at least one of titanium, vanadium, chromium, titanium oxide, vanadium oxide, and chromium oxide.

2. The optical component of claim 1, wherein a main component of the at least one intermediate layer is silicon dioxide.

3. The optical component of claim 1, wherein a main component of the at least one intermediate layer is same as one of components that form the nanostructure layer.

4. The optical component of claim 1, wherein the at least part of the metallic doping agent distributed inside the plurality of ridge-like protrusions gradually tapers in a direction away from the substrate.

5. The optical component of claim 1, wherein at least another part of the metallic doping agent is distributed on a surface of the plurality of ridge-like protrusions.

6. The optical component of claim 5, wherein a coverage thickness of the metallic doping agent on the surface of the plurality of ridge-like protrusions is greater than 1 nm and less than 40 nm.

7. The optical component of claim 6, wherein the coverage thickness of the metallic doping agent on the surface of the plurality of ridge-like protrusions is greater than 1 nm and less than 30 nm.

8. The optical component of claim 1, wherein a main component of the metallic doping agent is titanium oxide.

9. The optical component of claim 1, further comprising a matte structure, wherein the matte structure is integrally formed with the substrate, and the matte structure is located on one or some surfaces of the substrate and has an undulating shape.

10. The optical component of claim 9, wherein the matte structure has a plurality of protrusion portions, and the plurality of protrusion portions are regularly arranged.

11. The optical component of claim 10, wherein a height of the plurality of protrusion portions is greater than 40 μm and less than 1000 μm.

12. An optical component comprising:
a substrate having a reflection surface, wherein the reflection surface is configured to reflect light; and
an anti-reflective film disposed at least on one or some surfaces of the substrate, and the anti-reflective film comprising:
a nanostructure layer comprising a plurality of ridge-like protrusions that are non-directionally extended, wherein a bottom of the plurality of ridge-like protrusions is located closer to the substrate than a top of the plurality of ridge-like protrusions, the plurality of ridge-like protrusions gradually taper from the bottom toward the top, and an average structural height of the plurality of ridge-like protrusions is greater than 108 nm and less than 368 nm; and
at least one intermediate layer disposed between the nanostructure layer and the substrate;
wherein a main component of the nanostructure layer is aluminum oxide, the nanostructure layer further comprises a metallic doping agent, at least part of the metallic doping agent is distributed inside the plurality of ridge-like protrusions, and the metallic doping agent comprises at least one of titanium, vanadium, chromium, titanium oxide, vanadium oxide, and chromium oxide.

13. The optical component of claim 12, wherein a main component of the at least one intermediate layer is silicon dioxide.

14. The optical component of claim 12, wherein a main component of the at least one intermediate layer is same as one of components that form the nanostructure layer.

15. The optical component of claim 12, further comprising a light-blocking layer, wherein the light-blocking layer is located on one or some surfaces of the substrate and configured to block transmission of light.

16. The optical component of claim 15, wherein the anti-reflective film is further disposed on the light-blocking layer.

17. The optical component of claim 12, wherein the at least part of the metallic doping agent distributed inside the plurality of ridge-like protrusions gradually tapers in a direction away from the substrate.

18. The optical component of claim 12, wherein at least another part of the metallic doping agent is distributed on a surface of the plurality of ridge-like protrusions.

19. The optical component of claim 18, wherein a coverage thickness of the metallic doping agent on the surface of the plurality of ridge-like protrusions is greater than 1 nm and less than 40 nm.

20. The optical component of claim 19, wherein the coverage thickness of the metallic doping agent on the surface of the plurality of ridge-like protrusions is greater than 1 nm and less than 30 nm.

21. The optical component of claim 12, wherein a main component of the metallic doping agent is titanium oxide.

22. The optical component of claim 12, further comprising a matte structure, wherein the matte structure is integrally formed with the substrate, and the matte structure is located on one or some surfaces of the substrate and has an undulating shape.

23. The optical component of claim 22, wherein the matte structure has a plurality of protrusion portions, and the plurality of protrusion portions are regularly arranged.

24. The optical component of claim 23, wherein a height of the plurality of protrusion portions is greater than 40 μm and less than 1000 μm.

25. An imaging lens comprising:
the optical component of claim 1;
wherein an optical axis of the imaging lens passes through the optical component.

26. An electronic device comprising:
the imaging lens of claim 25; and
an image sensor disposed on an image surface of the imaging lens.

27. An imaging lens comprising:
the optical component of claim 12;
wherein an optical axis of the imaging lens passes through the optical component.

28. An electronic device comprising:
the imaging lens of claim 27; and
an image sensor disposed on an image surface of the imaging lens.
